(19) United States
(12) Patent Application Publication
(10) Pub. No.: US 2008/0205074 A1
(43) Pub. Date: Aug. 28, 2008

(54) Semiconductor Light Engine for Automotive Lighting

(76) Inventor: Ronald Owen Woodward, Yorktown, VA (US)

Correspondence Address: MAGNA INTERNATIONAL, INC., 337 MAGNA DRIVE, AURORA, ON, L4G-7K1, CA

(21) Appl. No.: 11/994,415

(22) PCT Filed: Jul. 12, 2006
(86) PCT No.: PCT/US2006/027029

§ 371 Date: Jan. 2, 2008

Related U.S. Application Data
(60) Provisional application No. 60/698,529, filed on Jul. 12, 2005.

(51) Int. Cl. B60Q 1/00

(52) U.S. Cl. 362/487

(57) ABSTRACT

A light engine (20) to provide light from a plurality of semiconductor light sources (40) in an automotive lighting system, such as a headlamp, includes a substrate (24) upon which the semiconductor light sources are mounted. The semiconductor light sources are spaced from one another on the substrate for cooling purposes. The substrate also preferably includes at least one layer (48) of heat transfer material which assists in transferring waste heat from the semiconductor light sources to a heat sink or other cooling means. The light engine (20) further includes a transfer device (28) comprising a bundle of fiber optic cables (60), one cable for each semiconductor light source (40), and each cable has a receiving end (32) which is located adjacent a respect one semiconductor light source (40) and an emitter end (36) which is located in close proximity to the emitter end of each other cable emitter end. The substrate (24) can be located in a location which is convenient for the purposes of cooling the semiconductor light sources while the emitter end of the cables of the transfer device can be located adjacent a lens of the headlamp or other automotive lighting system.

### CROSS-REFERENCE TO RELATED APPLICATION

This application claims the benefit of U.S. Provisional Application No. 60/698,529 filed Jul. 12, 2005, the entire specification of which is expressly incorporated herein by reference.

### FIELD OF THE INVENTION

This application relates to a light source for automotive lighting systems and the like. More specifically, this application relates to a semiconductor light engine to provide light for automotive lighting systems and the like.

### BACKGROUND OF THE INVENTION

Automotive lighting systems, and in particular headlamp systems, require light sources capable of producing relatively bright light which can be formed into the necessary beam patterns, as defined and required by various safety regulations. Incandescent bulbs were employed as light sources for headlamp systems for many years with reasonably acceptable results.

To provide more light to improve the beam patterns produced by headlamp systems, quartz halogen (“Halogen”) and high intensity discharge (“HID”) bulbs are now commonly used instead of incandescent bulbs, as Halogen and HID bulbs produce significantly more light than incandescent bulbs. However, such Halogen and HID light sources suffer from disadvantages in that they create a significant amount of waste heat which must be removed from the headlamp. Further, Halogen and HID headlamps require carefully designed optics to remove defects, from bulb filaments or bulb envelope influences, in the pattern of light they produce.

Accordingly, to provide proper cooling and/or the necessary optics, the enclosures of Halogen and HID headlamps must be relatively large and such large enclosures limit the aesthetic and/or aerodynamic designs which automotive designers could otherwise produce.

More recently, interest has developed in employing semiconductor light sources, such as light emitting diodes (“LED”s), as light sources for headlamp systems. LEDs which produce white light have become available and the amount of light produced by such LEDs has increased significantly in recent years. Ideally, headlamps employing LEDs as light sources will be able to be constructed with smaller enclosures than those required for conventional headlamps, allowing for the variety of aesthetic and aerodynamic vehicle designs to be increased.

However, LED-based headlamp systems also suffer from some disadvantages. The amount of light produced by available white LEDs is still insufficient to produce the required headlamp beam patterns and thus several closely positioned LEDs must be jointly employed to produce sufficient light. Further, the semiconductor junction produces a relatively large amount of waste heat when operating and this heat must be removed, by heat sinks, heat pipes and/or cooling fans and the like or the junction will fail. Thus, to provide for the proper arrangement of the multiple LED sources with respect to the lens of the LED headlamp and to provide adequate cooling of the LED sources, the enclosure of LED headlamps tend to be larger than is otherwise desired.

### SUMMARY OF THE INVENTION

It is an object of this application to provide a novel light engine which obviates or mitigates at least one disadvantage of the prior art.

According to a first aspect of the this application, there is provided a light engine for an automotive lighting system, comprising: a substrate; a plurality of semiconductor light sources mounted to the substrate, each adjacent semiconductor light source being spaced on the substrate from each other adjacent semiconductor light source on the substrate to enhance cooling of the semiconductor light sources during operation thereof; a transfer device operable to receive light emitted by the semiconductor light sources and to transfer the received light to another location spaced from the substrate, wherein the transfer device comprises a bundle of fiber optic cables, one cable for each respective semiconductor light source, and each cable having a receiving end located adjacent a respective one semiconductor light source, to receive light emitted therefrom, and an emitting end to emit the received light, the emitting ends being arranged in a smaller space than the space occupied by the semiconductor light sources on the substrate.

This application provides a light engine which provides light from a plurality of semiconductor light sources for an automotive lighting system, such as a headlamp. The light engine includes a substrate upon which the semiconductor light sources are mounted and the semiconductor light sources are spaced from one another on the substrate for cooling purposes. The substrate also preferably includes at least one layer of heat transfer material which assists in transferring waste heat from the semiconductor light sources to a heat sink or other cooling means. Examples of the cooling means could include AC systems, an engine cooling system, a Peltier Junction System, or fans and the like. The light engine further includes a transfer device comprising a bundle of fiber optic cables, one cable for each semiconductor light source, and each cable has a receiving end which is located adjacent a respect one semiconductor light source and an emitter end which is located in close proximity to the emitter end of each other cable emitter end. The substrate can be located in a different location from the location where the emitted light is needed. For example, the substrate can be located in a location which is convenient for the purposes of cooling the semiconductor light sources while the emitter end of the cables of the transfer device can be located adjacent a lens of the headlamp or other automotive lighting system.

### BRIEF DESCRIPTION OF THE DRAWINGS

Preferred embodiments of the teaching of the invention will now be described, by way of example only, with reference to the attached Figures, wherein:

FIG. 1 shows a schematic representation of a light engine in accordance with the teaching of the invention;

FIG. 2 shows a front view of a substrate and semiconductor light sources used in the light engine of FIG. 1;

FIG. 3 shows a side section taken along line 3-3 of FIG. 2;

FIG. 4 shows a section similar to that of FIG. 3 wherein one method of attaching fiber optic cables to the semiconductor light sources of the substrate is shown;

FIG. 5 shows a front view of an emitter end of a transfer device of the light engine of FIG. 1;

FIG. 6 shows a side view of the emitter end of FIG. 5 and a portion of the bundle of fiber optic cables of the light engine of FIG. 1;

FIG. 7 shows a schematic representation of a multi-beam source that is combined; and

FIG. 8 shows a schematic representation of a multi-beam source combining to make a higher intensity pattern.

### DETAILED DESCRIPTION OF THE INVENTION

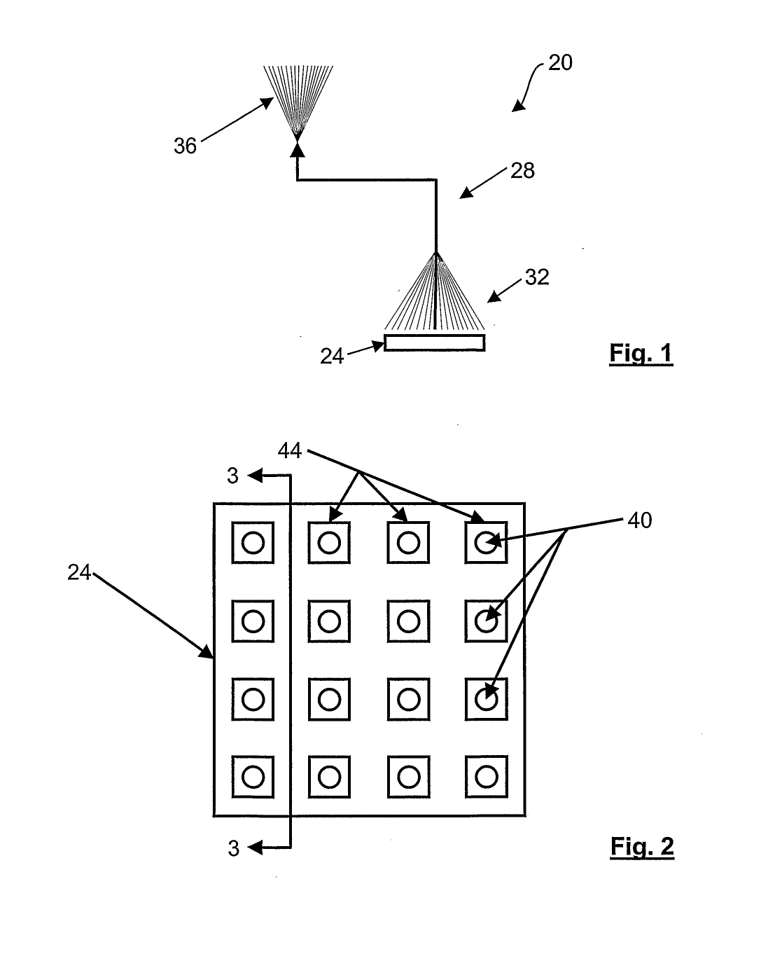

A light engine in accordance with this application is indicated generally at 20 is FIG. 1. Light engine 20 includes a substrate 24 and a transfer device 28 which includes a receiving end 32 and an emitter end 36.

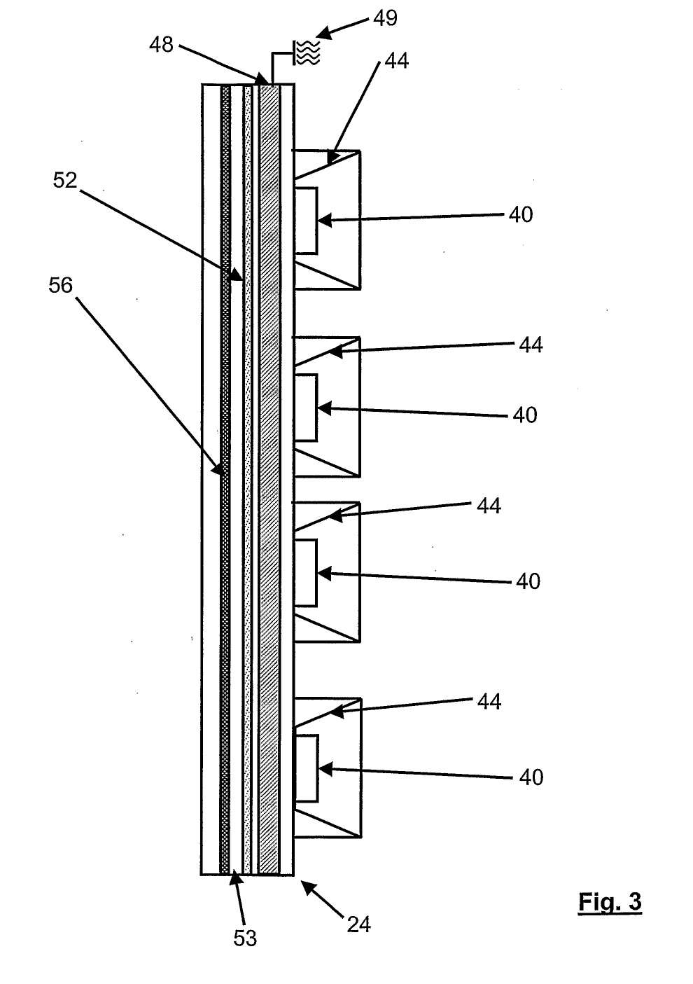

As shown in FIGS. 2 and 3, substrate 24 includes a plurality of semiconductor light sources 40, such as LEDs emitting white light, mounted thereon. Preferably, substrate 24 further includes a reflector 44 which surrounds each semiconductor light source 40 to direct the light emitted by each semiconductor light source 40 to the receiving end 32 of transfer device 28, as described in more detail below.

Semiconductor light sources 40 are mounted to substrate 24 with sufficient spacing between adjacent semiconductor light sources 40 to ensure that their junction temperatures can be maintained within the acceptable operating temperature range.

Substrate 24 can be formed of any suitable material as will be apparent to those of skill in the art and examples of such materials include ceramics, such as those used in packaging semiconductor integrated circuits, phenolics and/or epoxies, such as those used to fabricated printed circuit boards, etc.

Preferably, substrate 24 includes at least one layer 48 of a heat transfer material, such as copper or aluminum, which assists in the removal of waste heat generated within semiconductor light sources 40. Layer 48 can be connected to a suitable heat sink 49, heat pipe or heat wick when substrate 24 is mounted in a headlamp system. Layer 48, in combination with the above mentioned spacing of semiconductor light sources 40 on substrate 24, ensures that semiconductor light sources 40 can be operated within their specified operating temperature range.

Substrate 24 also preferably includes two layers 52 and 56, each being one of a positive and negative electrical conductor to which semiconductor light sources 40 are connected and are powered thereby. Insulation material 53 can be positioned between electrical conductors 52 and 56, or elsewhere as desired. Moreover, circuit elements can be on the same side of the LED's. Alternatively, positive and negative electrical conductors can be provided as conductive traces of the top, bottom or both of the top and bottom of substrate 24.

Each reflector 44 preferably include a parabolic shaped surface which surrounds its respective semiconductor light source 40 and reflectors 44 can be fabricated from any suitable material, such as epoxy or polycarbonate, to which a suitable reflective coating can be applied or reflectors 44 can be fabricated from a reflective material such as aluminum.

In the illustrated embodiment, each reflector 44 is shown as being a separate component mounted to substrate 24 individually, but it is also contemplated that reflectors 44 can be fabricated as a unit. For example, reflectors 44 can be molded as an assembly from an epoxy material, to which a reflective material is then applied, and the assembly being mounted to substrate 24, over semiconductor light sources 40, after semiconductor light sources 40 have been mounted to substrate 24. Similarly, reflectors 44 can be machined as an assembly from a billet of aluminum, or the like, and then mounted to substrate 24. In this latter case, the assembly of reflectors 44 can also assist in the removal of waste heat produced by semiconductor light sources 40.

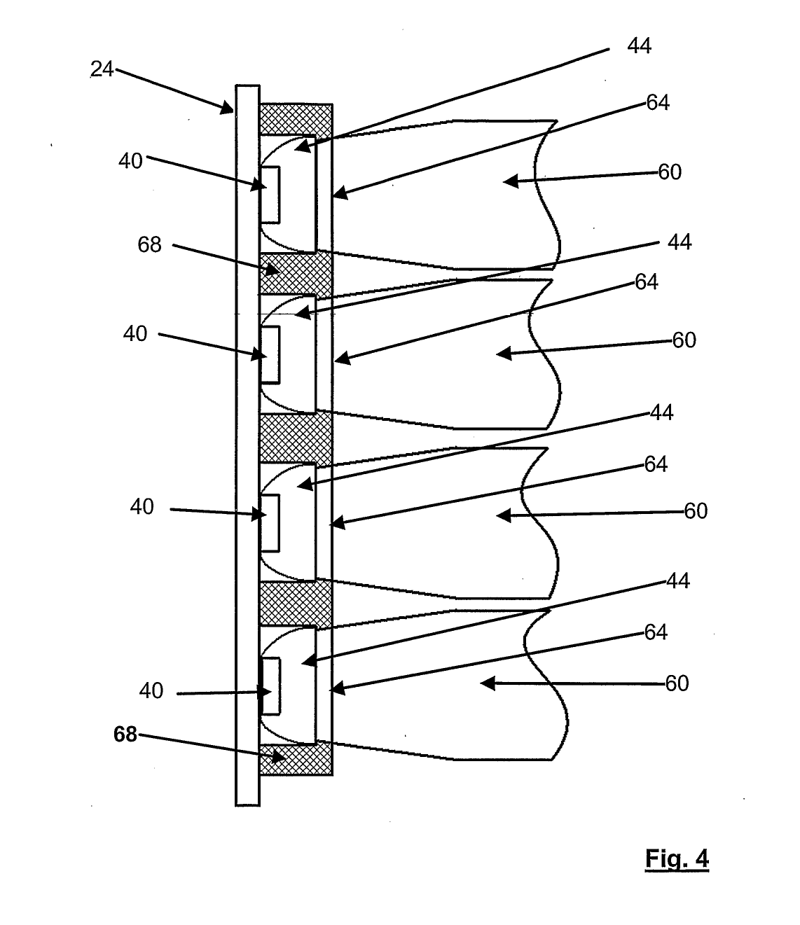

As shown in FIGS. 1, 4 and 6, transfer device 28 comprises a bundle of fiber optic cables 60, one per each semiconductor light source 40. At receiving end 32 of transfer device 28, best shown in FIG. 4, each respective fiber optic cable 60 is positioned adjacent a respective semiconductor light source 40 and reflector 44 (if present). Preferably, the receiving ends of the fiber optic cables include substantially optically flat surfaces 64 which are positioned substantially perpendicularly to semiconductor light sources 40 to capture a substantial portion of the light emitted by semiconductor light sources 40. The receiving ends of the fiber optic cables are maintained in place by epoxy 68 or by mechanical means (not shown).

Preferably, the diameter of the receiving ends of the fiber optic cables are tapered, from a diameter substantially the size of the outer end of reflector 44 (if present) or substantially the size of semiconductor light source 40 (if no reflector 44 is present) to a larger diameter along the length of fiber optic cable 60 to emitter end 36. As will be understood by those of skill in the art, such a taper will improve the amount of the light emitted by semiconductor light source 40 which is received by the respective fiber optic cable 60 and transmitted along its length.

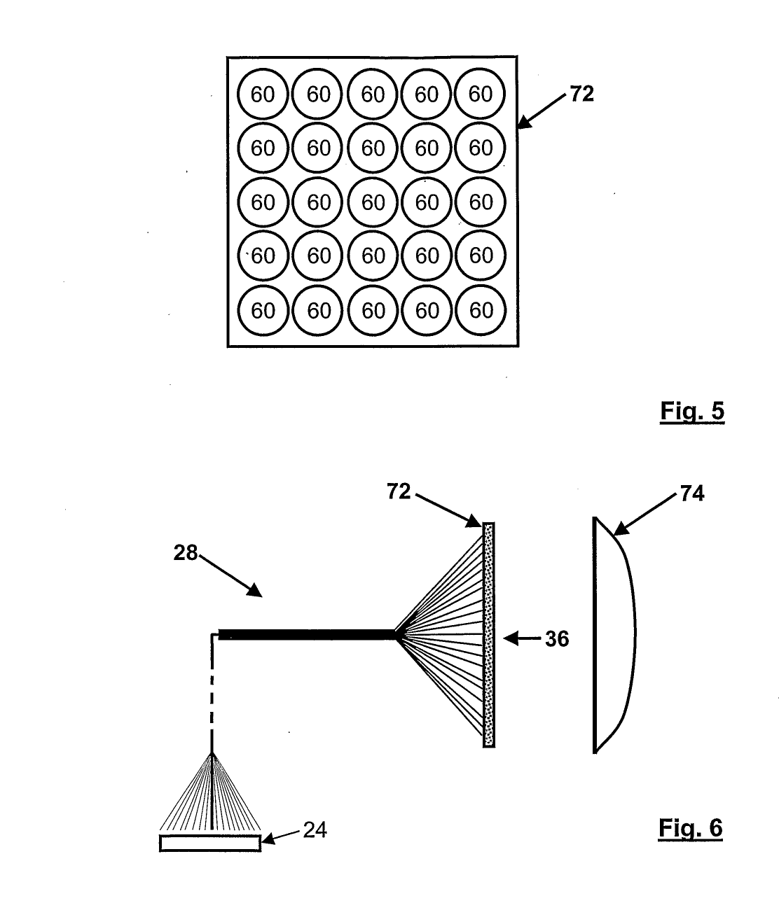

As shown in FIGS. 5 and 6, emitting end 36 of transfer device 28 preferably includes a forming member 72 which maintains the emitting ends of each fiber optic cable closely adjacent one another and substantially aligned, such that the light emitted from each fiber optic cable is substantially parallel to the light emitting by each other fiber optic cable 60. Forming member 72 can be an epoxy member cast about the ends of the fiber optic cables 60 in transfer device 28, or can be a planar member, such as a phenolic board, aluminum sheet or the like, with suitably sized apertures to receive the respective ends of fiber optic cables 60. Forming member can also be used as a mounting member to retain emitter end 36 in a desired position with respect to a lens system 74 or other component within a headlamp system or the like.

While not illustrated, it is also contemplated that fiber optic cables 60 at emitting end 36 can taper from the above-mentioned larger diameter of the majority of their run length to a smaller diameter at their ends adjacent forming member 72 to increase the amount of light emitted from each fiber optic cable 60.

As will be apparent, the spacing between the emitting ends of fiber optic cables 60 can be much closer than the spacing of semiconductor light sources 40 on substrate 24. Thus, transfer device 28 allows semiconductor light sources 40 to be spaced to meet thermal requirements and yet allows the light emitted by semiconductor light sources 40 to be provided to a headlamp lens system in a much closer spaced configuration.

As should now be apparent to those of skill in the art, light engine 20 provides several advantages for semiconductor-based headlamps. In prior art semiconductor headlamp systems, the semiconductor light sources had to be located adjacent the lens of the headlamp system to form the desired beam patterns. Electrical connections and heat removal systems thus had to be designed and arranged to work with the location of the light sources and the resulting heat transfer characteristics would often be less efficient than desired while the overall enclosure size and/or shape for the headlamp system would also be less favorable than desired.

In contrast, with light engine 20, transfer device 28 removes the need for the semiconductor light sources themselves to be located at any specific location with respect to the lens of the headlamp system. Instead, emitter end 36 of transfer device 28 must be appropriately positioned with respect to the lens, but substrate 24, with semiconductor light sources 40 and the required electrical and heat transfer connections thereto, can be located in a variety of locations within the enclosure of the headlamp system. For example, substrate 24 can be located horizontally along the bottom of a headlamp enclosure while emitter end 36 of transfer device 28 is located at the front of the headlamp enclosure, adjacent the lens. In such a configuration, substrate 24 can be thermally connected to one or more heat sinks which extend from the bottom of the headlamp enclosure, etc.

Further, light engine 20 can be used as a standard light engine from which a wide variety of headlamp or other lighting systems can be constructed. Light engine 20 provides a known amount of light and a headlamp system can employ one or more light engines 20, as needed, to produce a required lighting level. Each such light engine 20 could be directed towards supplying light to a hi-intensity portion of the beam while another light engine 20 could be used to supply light to a lower intensity wide spread portion of the pattern. Thus, it will be appreciated that separate light engine 20 can be associated in order to create a plurality of different light conditions as desired for the application. By producing standardized light engines 20, manufacturing costs can be reduced, design processes simplified and repair of headlamp systems simplified.

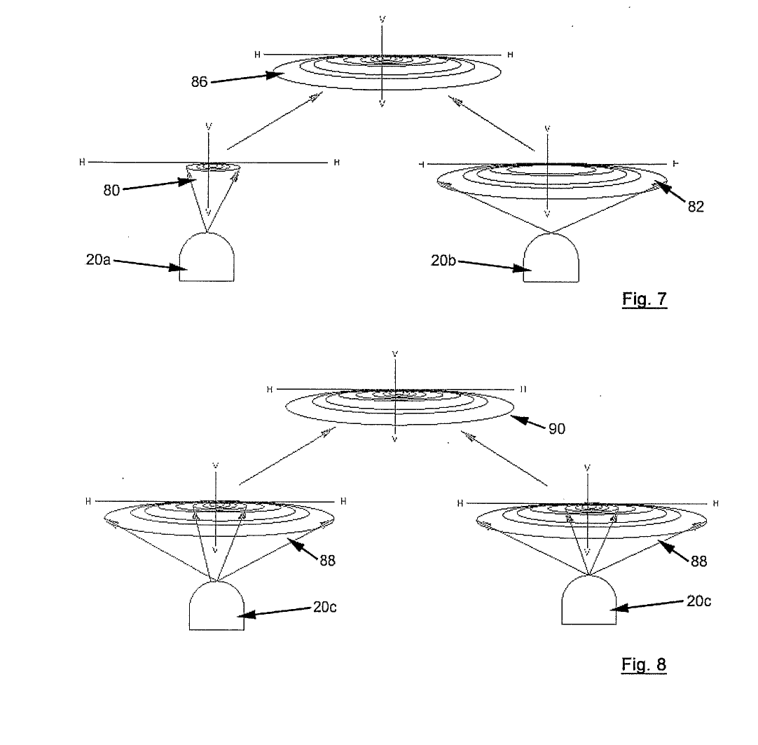

FIG. 7 is an example of a light source 20a producing a hi-intensity beam of light 80. Another light source 20b creates a wide spread pattern 82. Together they create a pattern 86 having the combination thereof. FIG. 8 is another example of multiple sets of light sources being used where projector or source 20c generates a pattern 88 and an identical source 20c creates a similar pattern 88 to collectively generate a resulting higher intensity pattern 90.

The above-described embodiments of the invention are intended to be examples of this application and alterations and modifications may be effected thereto, by those of skill in the art, without departing from the scope of the invention which is defined solely by the claims appended hereto.

1. A light engine for an automotive lighting system, comprising:
a substrate;
a plurality of semiconductor light sources mounted to the substrate, each adjacent semiconductor light source being spaced on the substrate from each other adjacent semiconductor light source on the substrate to enhance cooling of the semiconductor light sources during operation thereof;
a transfer device operable to receive light emitted by the semiconductor light sources and to transfer the received light to another location spaced from the substrate, wherein the transfer device comprises a bundle of fiber optic cables, one cable for each respective semiconductor light source, and each cable having a receiving end located adjacent a respective one semiconductor light source, to receive light emitted therefrom, and an emitting end to emit the received light, the emitting ends being arranged in a smaller space than the space occupied by the semiconductor light sources on the substrate.

2. The light engine of claim 1 further comprising a forming member to receive the emitting end of fiber optic cable and to maintain the emitting ends in a planar arrangement wherein the light is emitted by each fiber optic cable is substantially parallel to the light emitted by each other fiber optic cable.

3. The light engine of claim 1 further comprising a reflector surrounding each respective semiconductor light source on the substrate, the reflector operable to direct light emitted from the respective semiconductor light source into the receiving end of the respective fiber optic cable.

4. The light engine of claim 1 wherein the substrate further includes a layer of heat transfer material to assist in the removal of heat generated by the operation of the semiconductor light sources.

5. The light engine of claim 4 wherein the layer of heat transfer material is thermally connected to a heat sink.

6. The light engine of claim 1 wherein the receiving end of each fiber optic cable has a smaller diameter than the portion of the fiber optic cable between the receiving end and the emitting end.

7. The light engine of claim 6 wherein the emitting end of each fiber optic cable has a smaller diameter than the portion of the fiber optic cable between the receiving end and the emitting end.

8. An automotive lighting system, comprising:
a substrate;
a plurality of light sources mounted to the substrate; and
a transfer device operable to receive light emitted by the light sources and to transfer the received light to another location spaced from the substrate.

9. The lighting system as claimed in claim 8, wherein the transfer device comprises a bundle of fiber optic cables, one cable for each light source, and each cable having a receiving end located adjacent a respective light source.

10. The lighting system as claimed in claim 8, wherein the transfer device comprises an emitting end to emit the received light, the emitting end being arranged in a smaller space than a space occupied by the light sources on the substrate.

11. The lighting system as claimed in claim 8, wherein the substrate includes a heat sink layer and an electrical conductor layer.

12. The lighting system as claimed in claim 8, further comprising a reflector connected to the substrate and a light source disposed within the reflector.

13. The lighting system as claimed in claim 8, wherein the transfer device includes a receiving end having a plurality of light transfer members, each said light transfer member being operable to be received by a light source.

14. The lighting system as claimed in claim 8, further comprising a heat sink associated with the substrate.

15. The lighting system as claimed in claim 8, wherein one of the light sources generates light for a hi-intensity beam and another light source generates a low spread portion of a light.

16. A lighting system comprising:
a substrate having layers of conductive and non-conductive material;
a heat sink connected to the substrate;
light sources affixed to the substrate; and
a fiber optic member connected to each light source for delivering light to a lens.

17. The lighting system as claimed in claim 16, further comprising a reflector adjacent to each light source and operable to receive the fiber optic member.

18. The lighting system as claimed in claim 16, wherein the fiber optic member is part of a transfer device having a receiving end and an emitting end.

19. The lighting system as claimed in claim 16, further comprising a forming member that is operable to receive an end of the fiber optic member.

20. The lighting system as claimed in claim 16, further comprising a lens that receives light from each fiber optic member.
